(19) United States
(12) Patent Application Publication
(10) Pub. No.: US 2012/0015203 A1
(43) Pub. Date: Jan. 19, 2012

(54) TROPHY AND METHOD FOR ASSEMBLING A TROPHY

(75) Inventor: Alessandro Riverditi, Barbaresco (IT)

(73) Assignee: DAIMEX S.R.L., Piacenza (IT)

(21) Appl. No.: 12/917,942

(22) Filed: Nov. 2, 2010

(30) Foreign Application Priority Data
Jul. 15, 2010 (IT) PR2010A000061

(51) Int. Cl. A47G 35/00; B23P 11/00

(52) U.S. Cl. 428/542.4; 29/428

(57) ABSTRACT

Trophy (1) including: a base (2); a cup (3); a stem (4) having a joint portion (7) able to engage in a hole (8) in the base (2) and a threaded portion (9) able to engage in a threaded hole obtained in the bottom (3a) of the cup (3).

The present invention relates to a trophy and a method for assembling a trophy, formed in particular by a cup, a stem and a base.

The assemblable trophies today present on the market, despite envisaging minimal structural variants, all share the presence of a central tie rod which passes through the stem from end to end and represents the element for interconnecting the base and cup with the stem. For example, the document EP1095602 describes an assembly method wherein a first end of the central rod or tie rod is fixed to the base by means of a cap nut, whereas the second end of the rod is fixed to the cup by means of a screw.

The main disadvantage of the known solutions resides in the complexity of assembly, since the central tie rod renders the various steps interdependent, requiring the operator to simultaneously handle the base, the stem and the cup, following a precise assembly sequence. In fact, in the document EP1095602 it is mandatory first to fix the stem to the plinth and then the cup to the stem.

Moreover, assemblable trophies require other elements in addition to the cup, stem and base: at the very least they require a tie rod and two elements for retaining the tie rod at both ends.

Furthermore, precisely the use of a tie rod poses limits on the shape of the stem, which must have a through hole to accommodate the tie rod, with consequences for the overall appearance of the trophy.

In this context, the technical task at the basis of the present invention is to propose a trophy and a method for assembling a trophy which overcome the limitations of the above-mentioned prior art.

In particular, it is an object of the present invention to provide a simple, versatile and rapid method for assembling a trophy.

Another object of the present invention is to provide a trophy that requires a smaller number of interconnecting elements compared to the known trophies, so that it is more compact and economical to store in the disassembled configuration.

The defined technical task and the specified objects hereof are substantially achieved by a trophy and a method for assembling a trophy which comprise the technical characteristics described in one or more of the appended claims.

Further characteristics and advantages of the present invention will become more apparent from the following approximate, and hence non-restrictive, description of a preferred, but not exclusive, embodiment of a trophy and a method for assembling a trophy, as illustrated in the appended drawings, in which:

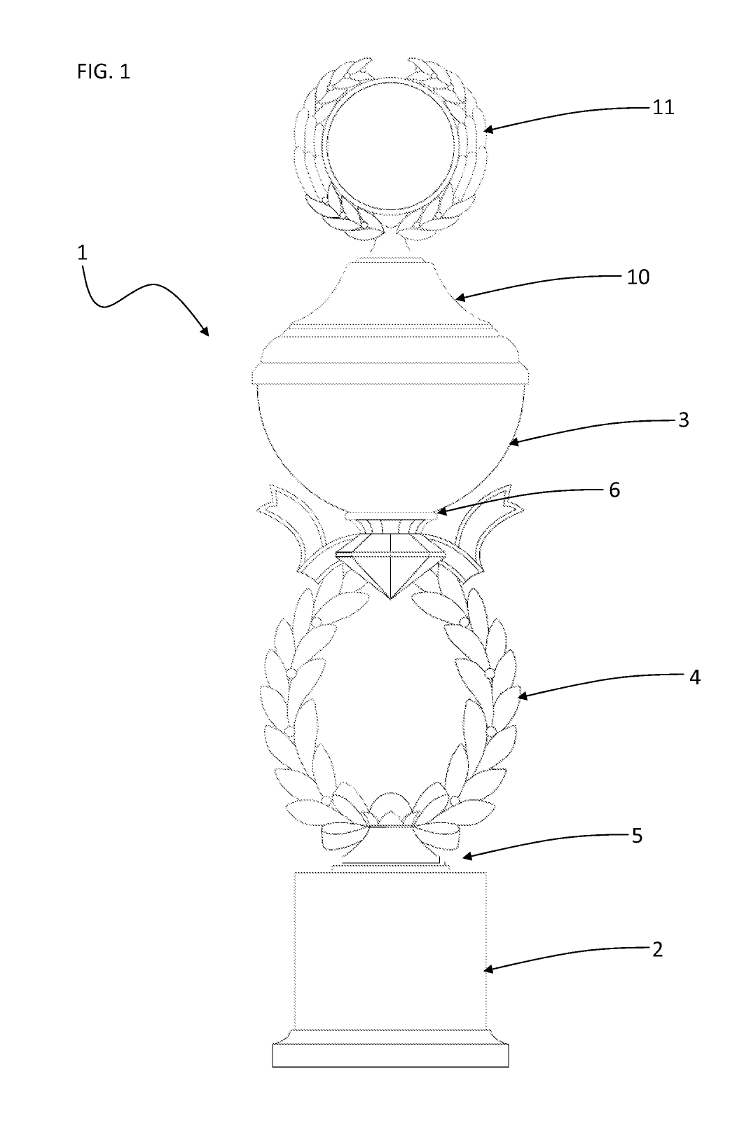

FIG. 1 illustrates a front view of a trophy, according to the present invention;

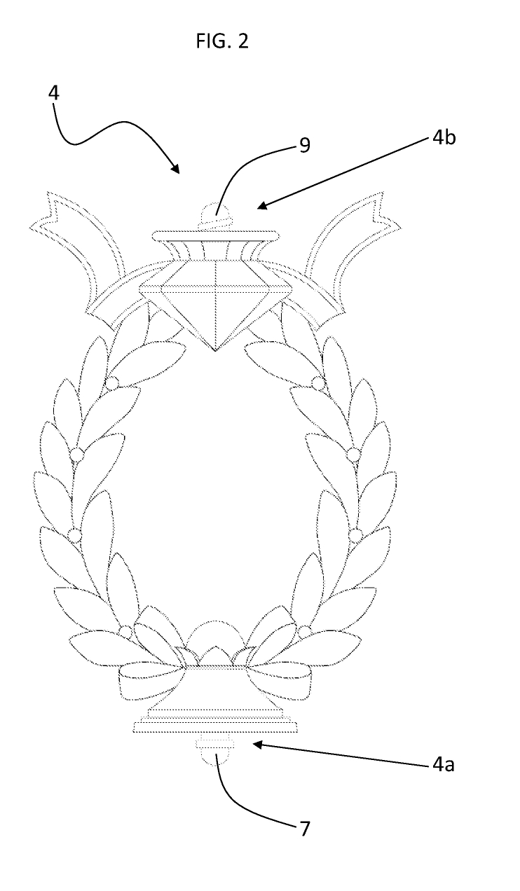

FIG. 2 illustrates a front view of a detail (stem) of the trophy of FIG. 1;

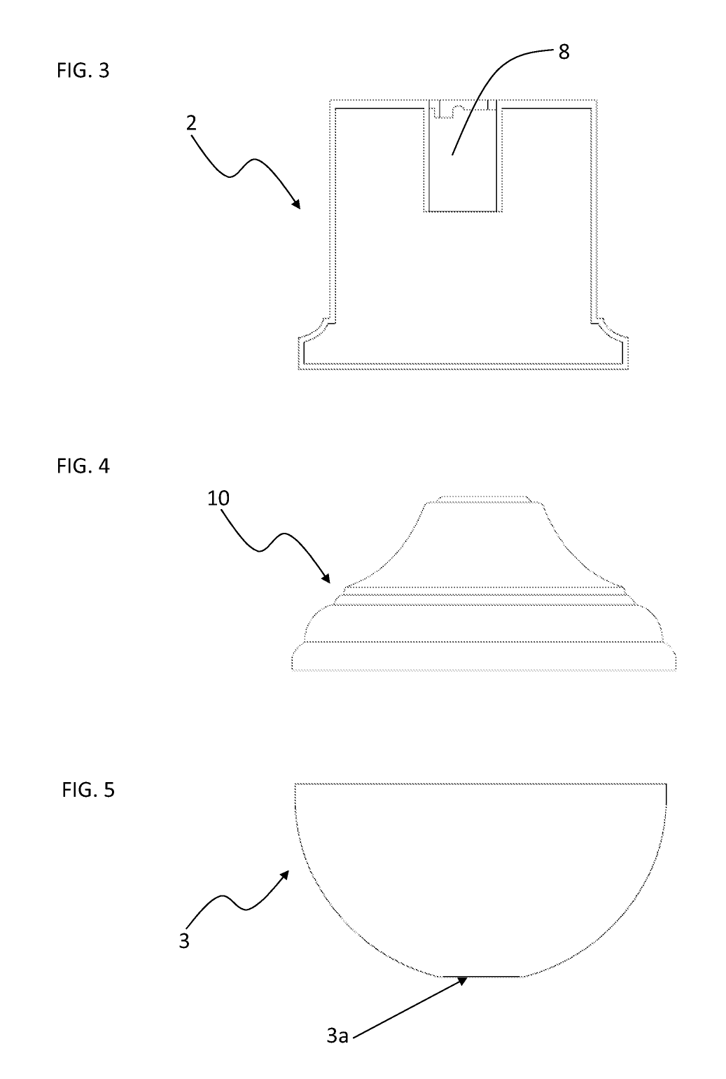

FIG. 3 illustrates a front cross-sectional view of a detail (base) of the trophy of FIG. 1;

FIG. 4 illustrates a front view of a detail (cap) of the trophy of FIG. 1;

FIG. 5 illustrates a front view of a detail (cup) of the trophy of FIG. 1.

With reference to the figures, 1 indicates a trophy comprising a base 2, a cup 3 and a stem 4 interposed between the base 2 and the cup 3. For example, the base 2 has a substantially parallelepiped shape (see FIG. 3), or else it has a tapered shape.

A first end 4a of the stem 4 is fixed to the base 2 in a first interconnecting section 5. A second end 4b of the stem 4 is fixed to the bottom 3a of the cup 3 in a second interconnecting section 6. Originally, the interconnecting sections 5, 6 are independent from each other, i.e. not connected, in such a way as to originate at least an intermediate assembly formed by the base 2 and the stem 4 or by the cup 3 and the stem 4. Advantageously, the first end 4a of the stem 4 is mounted directly, i.e. without the use of additional fastening elements, on the base 2. Similarly, the second end 4b of the stem 4 is likewise mounted directly, i.e. without the use of additional fastening elements, on the cup 3.

In the embodiment described and illustrated here, the first interconnecting section 5 is formed by a bayonet coupling. In fact, the first end 4a of the stem 4 presents a joint portion 7 able to engage in a hole 8 obtained in the base 2.

The second interconnecting section 6 is obtained by screwing the second end 4b of the stem 4 to the bottom 3a of the cup 3. In particular, the second end 4b of the stem presents a threaded portion 9 able to engage in a threaded hole obtained in the bottom 3a of the cup 3.

In an alternative embodiment (not illustrated), the first interconnecting section 5 is obtained by screwing the first end 4a of the stem 4 to the base 2. Another embodiment (not illustrated) envisages that the second interconnecting section 6 consists of a bayonet coupling.

Preferably, the cup 3 is made of metal material. The trophy 1 is provided with a removable cap 10 which is maintained in a configuration of closure of the cup 3 by magnetic means. In the embodiment described and illustrated here, the top of the cap 10 bears a fitted medal holder 11, in particular fixed with a rapid joint.

The method for assembling a trophy formed by a cup, a stem and a base, according to the present invention, is described hereunder.

The first end 4a of the stem 4, and more precisely the joint portion 7, is inserted in the hole 8 of the base 2 and turned in such a way as to define the bayonet coupling 5. The second end 4b of the stem 4, and more precisely the threaded portion 9, is screwed into the threaded hole on the bottom 3a of the cup 3.

Originally, the step of mounting the stem 4 on the base 2 and the step of mounting the cup 3 on the stem 4 are independent from each other, i.e. feasible in different times so as to originate at least an intermediate assembly formed by the base 2 and the stem 4 or by the cup 3 and the stem 4. For example, it is possible to carry out first the step of mounting the stem 4 on the base 2 and then the step of mounting the cup 3 on the stem 4 (already fixed to the base 2). Alternatively, it is possible to carry out first the step of mounting the cup 3 on the stem 4 and then the step of mounting the stem 4 (already bearing the cup 3) on the base 2.

The characteristics of the trophy and the method for assembling a trophy according to the present invention are readily apparent from the description provided, as are the advantages thereof.

In particular, thanks to the fact that the two interconnecting sections between the stem and base and between the stem and cup are independent from each other, assembly of the trophy proves to be extremely versatile. In fact, it is possible to follow any assembly sequence: first the stem on the base and then the cup on the stem, or first the cup on the stem and then the stem on the base.

The absence of a central tie rod moreover allows the stem to be made in any shape whatsoever (in the case illustrated, the stem has the shape of a laurel wreath).

Furthermore, assembly is rapid since it entails only fitting or screwing.

Moreover, as no additional elements are necessary besides the cup, stem and base, the disassembled trophy has more compact dimensions than the presently known trophies.

Finally, the magnetic coupling between the cup and the cap avoids the risk of the cap being dropped, for example during the prize awarding phase.

1. Trophy (1) comprising:
a base (2);
a cup (3);
a stem (4) interposed between the base (2) and the cup (3),
characterised in that it comprises a first interconnecting section (5) between the base (2) and a first end (4a) of the stem (4) and a second interconnecting section (6) between the bottom (3a) of the cup (3) and a second end (4b) of the stem (4), said interconnecting sections (5, 6) being independent from each other, i.e. not connected, in such a way as to originate at least an intermediate assembly formed by the base (2) and the stem (4) or by the cup (3) and the stem (4).

2. Trophy (1) according to claim 1, wherein said first interconnecting section (5) is formed by a bayonet coupling.

3. Trophy (1) according to claim 2, wherein the first end (4a) of the stem (4) presents a joint portion (7) able to engage in a hole (8) obtained in the base (2) in such a way as to define a bayonet coupling (5).

4. Trophy (1) according to claim 1, wherein the second interconnecting section (6) is obtained by screwing the second end (4b) of the stem (4) to the bottom (3a) of the cup (3).

5. Trophy (1) according to claim 4, wherein the second end (4b) of the stem (4) presents a threaded portion (9) able to engage in a threaded hole obtained in the bottom (3a) of the cup (3).

6. Trophy (1) according to claim 1, further comprising a removable cap (10) that is maintained in a closed configuration of the cup (3) by magnetic means.

7. Trophy (1) according to claim 6, wherein the cap (10) bears, on its top, a medal holder (11) fixed with a rapid joint.

8. Method for assembling a trophy (1) formed by a cup (3), a stem (4) and a base (2), comprising the step of:
mounting the stem (4) on the base (2) by interconnecting a first end (4a) of the stem (4) to the base (2) itself;
mounting the cup (3) on the stem (4) by interconnecting the bottom (3a) of the cup (3) to a second end (4b) of the stem (4),
characterised in that the step of mounting the stem (4) on the base (2) and the step of mounting the cup (3) on the stem (4) are independent from each other, i.e. are feasible in different times so as to originate at least an intermediate assembly formed by the base (2) and the stem (4) or by the cup (3) and the stem (4).

9. Method according to claim 8, wherein the step of mounting the stem (4) on the base (2) takes place by inserting the first end (4a) of the stem (4) in a hole (8) obtained in the base (2) and by rotating said first end (4a) in such a way as to define a bayonet coupling (5).

10. Method according to claim 8, wherein the step of mounting the cup (3) on the stem (4) takes place by screwing the second end (4b) of the stem (4) to the bottom (3a) of the cup (3).

11. Method according to claim 8, wherein the step of mounting the cup (3) on the stem (4) takes place before or after the step of mounting the stem (4) on the base (2).
